(19) United States
(12) Patent Application Publication
(10) Pub. No.: US 2007/0175716 A1
(43) Pub. Date: Aug. 2, 2007

(54) Shock absorber generator

(76) Inventors: David Dong Kim, Cerritos, CA (US); Sam Young Kim, Cerritos, CA (US)

Correspondence Address: Eugene Oak, 12647 Lucas St., Cerritos, CA, 90703, US

(21) Appl. No.: 11/346,505

(22) Filed: Feb. 2, 2006

(51) Int. Cl. F16F 15/03

(52) U.S. Cl. 188/267

(57) ABSTRACT

A car's shock absorber equipped for a generator produces electrical power and charges a hybrid car's battery, making use of the up-and-down vibration of a running car's shock absorbers. A shock absorber generator equips induction coils inside shock absorber's cylinder cover and permanent magnet rings outside a cylinder piston, so that a shock absorber transfers vibration power to electrical power with inductive action produced between induction coils and magnet rings inside the shock absorber. The vibration width of a shock absorber is between 0.25 inch and 0.5 inch, and the average vibration width is 0.375 inch so that vibration width is narrow, but the power of vibration is high enough to generate electricity, especially for heavy vehicles. With use of that vibration power, a shock absorber generates electricity and stores electric power in a hybrid car battery. As the driving period is prolonged, the shock absorber is able to generate larger amounts of electricity.

### SUMMARY OF THE INVENTION

A shock absorber which includes a shock absorber and a generator produces electricity by the use of vibration, and charges a battery while driving. A shock absorber equipped with inductive coils inside the cylindrical cover and permanent magnet rings outside cylindrical piston is unique combination of a shock absorber of a car and a generator. In the case that a hybrid car uses a shock absorber with a generator, a hybrid car is able to save gasoline by increasing energy efficiency while driving. Though the average length of the up-and-down vibration of a shock absorber is between 3.75 inch and 0.5 inch, a shock absorber equipped for a generator can produce electrical power. This is due to the permanent magnet rings and induction coil rings installed inside the shock absorber. An assembled shock absorber needs to be manufactured in aluminum, and the gap between the cylindrical cover and cylindrical piston must be narrow in order to increase strength of the magnetic field.

### BRIEF DESCRIPTION OF THE DRAWINGS

FIG. 1 is a shock absorber that is equipped for a generator.

FIG. 2 is a shock absorber's cylindrical cover equipped for induction coils.

FIG. 3 is an induction coil ring for cylinder cover.

FIG. 4 is a shock absorber's piston equipped for magnet rings.

FIG. 5 is structure of magnet ring for a shock absorber's piston.

### DETAILED DESCRIPTION OF THE PREFERRED EMBODIMENT

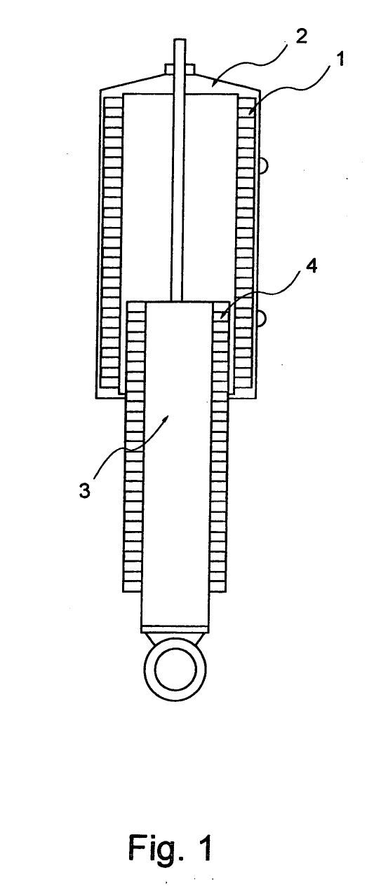

FIG. 1 is a shock absorber equipped for a generator. To install an assembly of induction coils (1), a cylindrical cover (2) is longer and thicker than an average shock absorber. To install a magnet (3), a piston (4) is also longer and thicker.

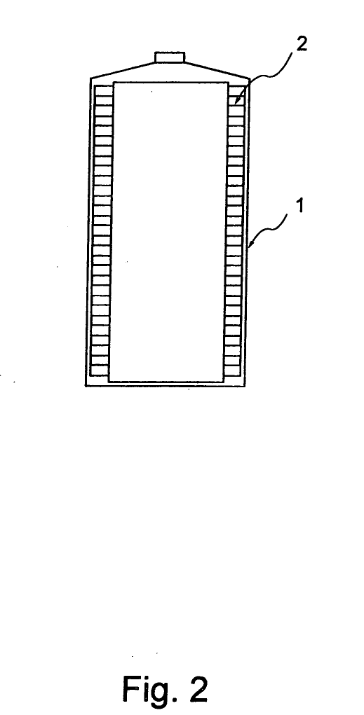

FIG. 2 is a cylindrical cover (1) equipped for magnet ring (2) for generator assembly.

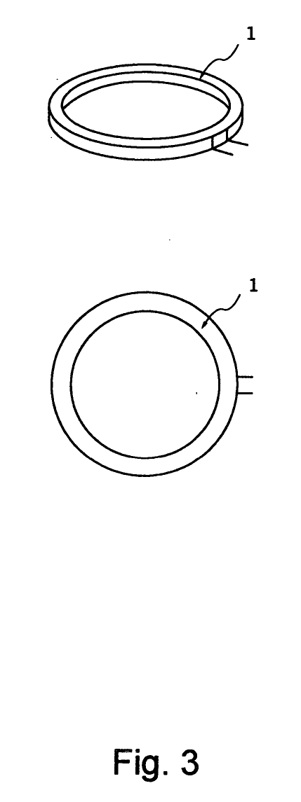

FIG. 3 is a ring shape assembly (1) with induction coil ring inside.

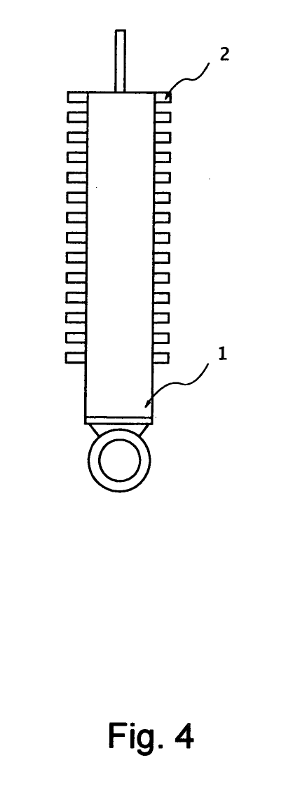

FIG. 4 is a shock absorber's piston (1) equipped magnet rings (2) outside.

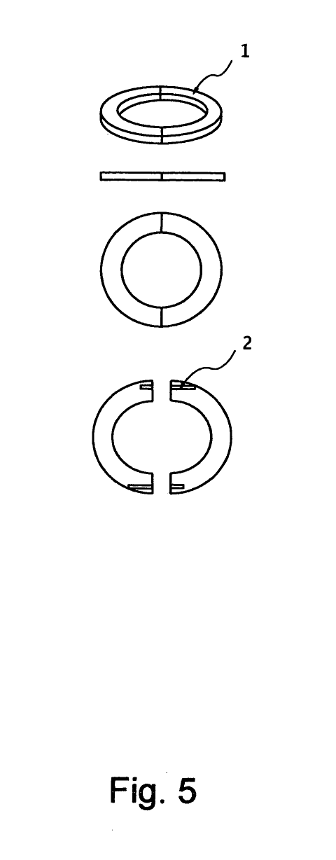

FIG. 5 is a ring shape assembly (1) and a fastener hole (2) for a screwdriver.

1. A shock absorber for changing vibration energy, which occurs because of the motion while driving a car whose average height of up-and-down motion is between 3.75 inches and 0.5 inches, into electric energy and charge it into a battery is comprised of;
a shock absorber cylinder cover that is 3 inches longer than conventional shock absorber cylinder and having diameter 2 inches larger than the conventional shock absorber cover, and pluralities of inductive coils, which are installed inside of the cylinder cover and wound with 1 inch thickness, and a piston whose diameter is 1 inch larger and length is 3 inches longer than the conventional shock absorber piston, and pluralities of permanent magnet rings, whose inside diameter is the same as the outside diameter of the piston and whose outside diameter is 1/64 inches smaller than the inside diameter of the inductive coils, installed outside of the piston.

2. A shock absorber of claim 1, wherein the absorber cylinder is made of stainless steel.

3. A shock absorber of claim 1, wherein the absorber cylinder is made of heat treated aluminum.

4. A shock absorber of claim 1, wherein the piston is made of stainless steel.

5. A shock absorber of claim 1, wherein the piston is made of heat treated aluminum.

6. A shock absorber for conversion of a mechanical energy, which occurs because of the up-and-down motion while driving a car, the average height of up-and-down motion is between 5.00 inches and 0.1 inches.

7. A shock absorber cylinder cover in claim 1 is 1-3 inches longer than conventional shock absorber cylinder.
